(19) United States
(12) Patent Application Publication
(10) Pub. No.: US 2011/0012832 A1
(43) Pub. Date: Jan. 20, 2011

(54) MOUSE STRUCTURE WITH MUSIC EDITING FUNCTION

(76) Inventor: Yu-Kuei LIU, Taoyuan City (TW)

Correspondence Address: Muncy, Geissler, Olds & Lowe, PLLC, 4000 Legato Road, Suite 310, FAIRFAX, VA, 22033, US

(21) Appl. No.: 12/506,061

(22) Filed: Jul. 20, 2009

(51) Int. Cl. G09G 5/08

(52) U.S. Cl. 345/163

(57) ABSTRACT

A mouse structure with a music editing function includes: a casing having a left button, a right button and a fader button; an operating mechanism installed in the casing, and having a processing unit, an input unit corresponding to the bottom of the casing, a select unit and a communication interface corresponding to the left and right buttons respectively; and a music editing mechanism, installed in the casing, and electrically coupled to the processing unit and controlled by the fader button. Therefore, the mouse structure with a music editing function concurrently has a mouse and both music mastering and editing functions to achieve the effects of a compact design, an easy-to-carry feature and a reduction of equipment cost.

### FIELD OF THE INVENTION

The present invention relates to a mouse structure with a music editing function, in particular to a mouse having both music mastering and editing functions to achieve the effects of a compact design, an easy-to-carry feature and a reduction of equipment cost.

### BACKGROUND OF THE INVENTION

In a music (or audio) recording, mastering or editing process, a large recording and editing tool is generally used together with a computer to record audio into the computer through a microphone, and then the recording and editing tool is used to adjust each audio track to complete related mastering and editing of the music.

Since the recording and editing tool is a large fixed operating panel that cannot be removed freely, and the installation of the recording and editing tool requires wiring and construction and incurs a high manufacturing cost, and the recording and editing tool is generally used together with a computer that is usually operated by a mouse, therefore an integration of the recording and editing tool and the mouse can overcome the drawbacks of the conventional recording and editing tool including a large volume, a poor portability and a high equipment cost.

Therefore, it is an important subject of the present invention to disclose a mouse structure with a music editing function, so as to achieve the effects of a compact design, an easy-to-carry feature and a reduction of equipment cost.

### SUMMARY OF THE INVENTION

In view of the aforementioned shortcomings of the conventional mouse structure with a music editing function, the inventor of the present invention based on years of experience in the related industry to conduct extensive researches and experiments, and finally developed a mouse structure with a music editing function in accordance with the present invention to achieve the effects of a compact design, an easy-to-carry feature and a reduction of equipment cost.

Therefore, it is a primary objective of the present invention to provide a mouse structure with a music editing function, wherein an operating mechanism and a music editing mechanism are provided for the mouse and music mastering and editing functions to achieve the effects of a compact design, an easy-to-carry feature and a reduction of equipment cost.

To achieve the foregoing objectives, the present invention provides a mouse structure with a music editing function, and the mouse structure comprises: a casing having a left button, a right button and a fader button installed on a surface of the casing; an operating mechanism installed in the casing and including an input unit, a select unit and a communication interface electrically coupled with a processing unit, wherein the input unit corresponds to the bottom of the casing, and the select unit corresponds to the right button; and a music editing mechanism coupled to the casing and electrically coupled to the processing unit, and controlled by the fader button.

Therefore, a mouse structure with a music editing function in accordance with the present invention concurrently has a mouse and both music mastering and editing functions to achieve the effects of a compact design, an easy-to-carry feature and a reduction of equipment cost.

### BRIEF DESCRIPTION OF THE DRAWINGS

FIG. 1 is a perspective view of the present invention;

FIG. 2 is a basic structural block diagram of the present invention; and

FIG. 3 is a block diagram of an application of the present invention.

### DESCRIPTION OF THE PREFERRED EMBODIMENTS

Other features and advantages of the present invention will become apparent in the following detailed description of the preferred embodiments with reference to the accompanying drawings.

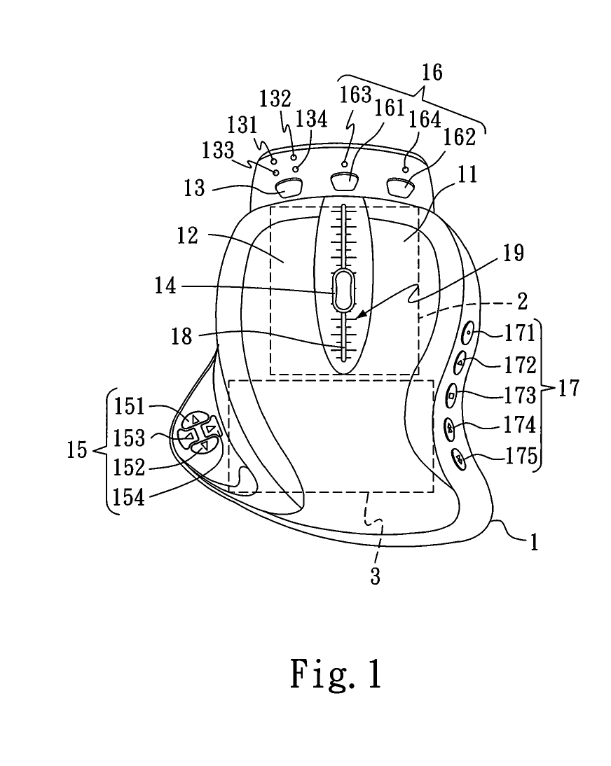

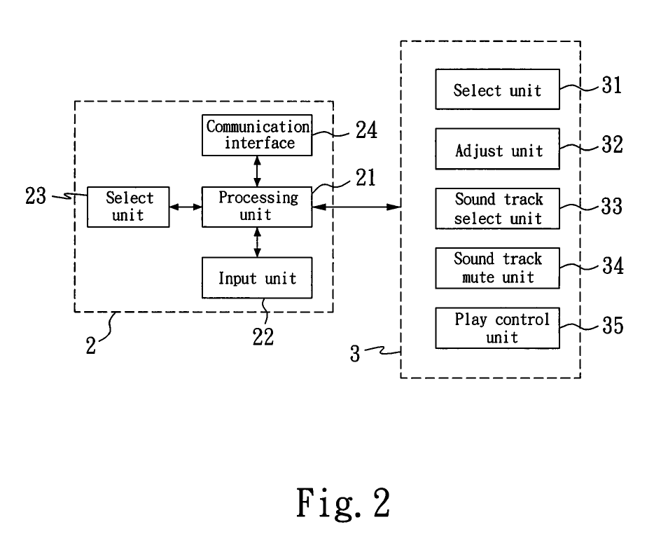

With reference to FIGS. 1 and 2 for a perspective view and a basic structural block diagram of the present invention respectively, a mouse structure with a music editing function of the invention comprises a casing 1, an operating mechanism 2 and a music editing mechanism 3.

The casing 1 comprises: a left button 11; a right button 12; a select button 13 having a plurality of display portions 131, 132, 133, 134 disposed on a side of the select button, a fader button 14; an audio track button area 15 including an up arrow button 151, a down arrow button 152, a left arrow button 153 and a right arrow button 154; a mute button area 16 including a single audio track mute button 161 and a multiple audio track mute button 162; and a play button area 17 including a record button 171, a start button 172, a stop button 173, a fast forward button 174 and a fast reverse button 175, wherein the casing 1 has a slide slot 18 provided for movably installing the fader button 14, a calibration area 19 disposed at the periphery of the slide slot 18, and a plurality of display portions 163, 164 disposed on a side of the single audio track mute button 161 and multiple audio track mute button 162 respectively, wherein each display portion 131, 132, 133, 134, 163, 164 can be a light emitting diode (LED) or a screen, and the LED is used in a preferred embodiment for illustrating the present invention.

The operating mechanism 2 is installed in the casing 1 and comprises a processing unit 21, and an input unit 22, a select unit 23 and a communication interface 24, each electrically coupled to processing unit 21. The input unit 22 corresponds to the bottom of the casing 1, and the select unit 23 corresponds to the left and right buttons 11, 12.

The music editing mechanism 3 is installed in the casing 1 and electrically coupled to the processing unit 21. The music editing mechanism 3 comprises a select unit 31 corresponding to the select button 13 and electrically coupled to the display portions 131, 132, 133, 134, an adjust unit 32 corresponding to the fader button 14, an audio track select unit 33 corresponding to audio track button area 15, an audio track mute unit 34 corresponding to mute button area 16 and electrically coupled to the display portion 163, 164, and a play control unit 35 corresponding to the play button area 17.

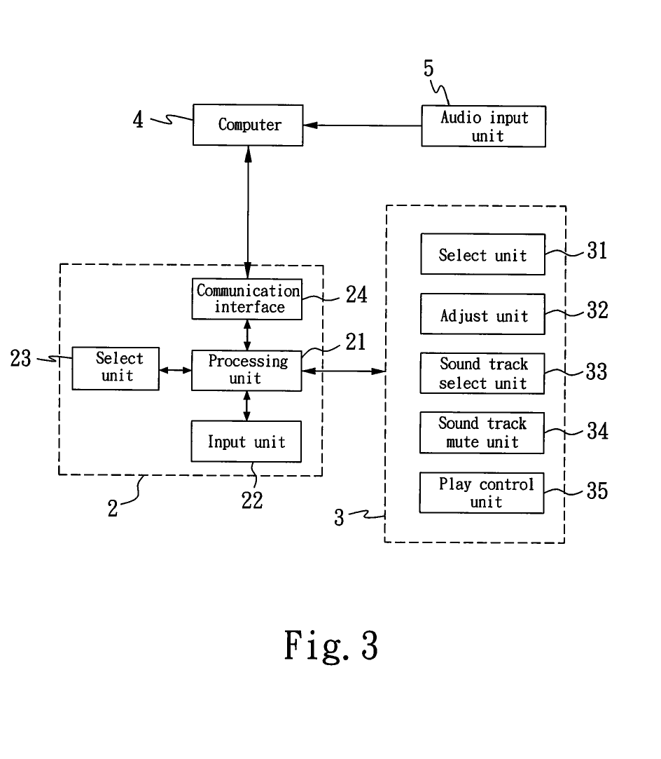

With reference to FIG. 3 for a block diagram of an application of the present invention, the communication interface 24 of the operating mechanism 2 is connected to a computer 4 through a cable or wireless communication protocol, and a processing unit 21, an input unit 22 and a select unit 23 are operated together with the left button 11 and the right button 12 for performing a page operation of the computer to achieve the effects of a mouse when the present invention is in use (refer to FIG. 1 at the same time).

In addition, an audio input unit 5 is connected to the computer 4 in another application, wherein the audio input unit 5 can be a microphone, a speaker or an audio recorder, such that the audio input unit 5 can capture an audio, and then store the audio as an audio file into the computer 4. A user can call the audio file and use the mouse of the invention and related software to edit the audio file, and the user can press the select button 13 repeatedly to start the select unit 31 and operate the fader button 14 and the adjust unit 32 to control the volume, record an audio or modify a section of a song for the audio file, and then save the audio file. If the user presses the select button 13 repeatedly to start the select unit 31, the display portion 131, 132, 133, 134 will emit a light in an appropriate color according to the user's selected function in order to provide the user a way of identifying the selected function. The user can further press the up arrow button 151, down arrow button 152, left arrow button 153 and right arrow button 154 in the audio track button area 15 to start the audio track select unit 33 to select an audio track of the audio file, and then operate the select button 13 and the fader button 14 to start the select unit 31 and the adjust unit 32 for editing the audio file, or press the single audio track mute button 161 and the multiple audio track mute button 162 in the mute button area 16 to start the audio track mute unit 34 for muting the single audio track or the multiple audio track of the audio file, and also select the fader button 14 to start the adjust unit 32 for editing each audio track of the audio file. If the user presses the single audio track mute button 161 or the multiple audio track mute button 162, the display portion 163, 164 will emit a corresponding light to provide the user a way of identifying the selected button. After the user identifies the selected button and completes editing the audio file, the user can press the record button 171, start button 172, stop button 173, fast forward button 174 or fast reverse button 175 in the play button area 17 to start the play control unit 35 to play the audio file. Of course, the select button 13, fader button 14, audio track button area 15, mute button area 16 and play button area 17 can be used independently to start the select unit 31, adjust unit 32, audio track select unit 33, audio track mute unit 34 and play control unit 35 to meet the actual requirements of editing music in a practical application of the present invention.

The present invention includes the operating mechanism and the music editing mechanism to provide a mouse and music mastering and editing functions concurrently, so as to achieve the effects of a compact design, an easy-to-carry feature and a reduction of equipment cost. Obviously, the present invention complies with the patent application requirements and the products produced according to the present invention can meet the current market requirements.

While the invention has been described by means of specific embodiments, numerous modifications and variations could be made thereto by those skilled in the art without departing from the scope and spirit of the invention set forth in the claims.

What is claimed is:

1. A mouse structure with a music editing function, comprising:
a casing, having a left button, a right button and a fader button installed on a surface of the casing;
an operating mechanism, installed in the casing, and comprising a processing unit, and an input unit, a select unit and a communication interface electrically coupled with a processing unit, and the input unit corresponding to the bottom of the casing, and the select unit corresponding to the left and right buttons; and
a music editing mechanism, installed in the casing, and electrically coupled to the processing unit, and controlled by the fader button.

2. The mouse structure with a music editing function as recited in claim 1, wherein the casing comprises a slide slot for movably installing the fader button, and a calibration area disposed around the periphery of the slide slot.

3. The mouse structure with a music editing function as recited in claim 1, wherein the casing further comprises a select button, a fader button, an audio track button area, a mute button area and a play button area, and the music editing mechanism comprises a select unit corresponding to the select button, an adjust unit corresponding to the fader button, an audio track select unit corresponding to the audio track button area, an audio track mute unit corresponding to the mute button area, and a play control unit corresponding to the play button area.

4. The mouse structure with a music editing function as recited in claim 3, wherein the select button comprises a plurality of display portions disposed on a side of the select button and electrically coupled to the select unit.

5. The mouse structure with a music editing function as recited in claim 4, wherein the display portion is a light emitting diode (LED) or a screen.

6. The mouse structure with a music editing function as recited in claim 3, wherein the audio track button area comprises an up arrow button, a down arrow button, a left arrow button and a right arrow button.

7. The mouse structure with a music editing function as recited in claim 3, wherein the mute button area comprises a single audio track mute button, a multiple audio track mute button, and a plurality of display portions disposed on a side of the single audio track mute button and the multiple audio track mute button respectively and electrically coupled to the audio track mute unit.

8. The mouse structure with a music editing function as recited in claim 7, wherein the display portion is a light emitting diode (LED) or a screen.

9. The mouse structure with a music editing function as recited in claim 3, wherein the play button area comprises a record button, a start button, a stop button, a fast forward button and a fast reverse button.

10. The mouse structure with a music editing function as recited in claim 1, wherein the communication interface of the operating mechanism further comprises a computer connected to an audio input unit.

11. The mouse structure with a music editing function as recited in claim 9, wherein the communication interface is connected to the computer through a cable or wireless communication protocol.
